(19) United States
(12) Patent Application Publication
(10) Pub. No.: US 2026/0319343 A1
(43) Pub. Date: Oct. 15, 2026

(54) LEG OF PHOTOGRAPHY SUPPORT APPARATUS AND PHOTOGRAPHY SUPPORT APPARATUS

(71) Applicant: SHENZHEN LEQI INNOVATION CO., LTD., SHENZHEN (CN)

(72) Inventor: SHAORUI TANG, SHENZHEN (CN)

(21) Appl. No.: 19/636,940

(22) Filed: Apr. 2, 2026

(30) Foreign Application Priority Data
Apr. 15, 2025 (CN) 202520711411.5

(51) Int. Cl. G03B 17/56; F16M 11/26

(52) U.S. Cl. CPC G03B 17/561; F16M 11/26; F16M 2200/028

(57) ABSTRACT

A leg of a photography support apparatus is provided. The photography support apparatus includes a mounting device for connecting a photography device. The leg is connected to the mounting device. The leg includes a plurality of sequentially nested tubular members. A locking mechanism is provided between any two adjacent tubular members. The leg further includes a driving mechanism drivingly connected to each locking mechanism. The driving mechanism is configured to drive each locking mechanism to configure any two adjacent tubular members in either a relatively fixed state or a relatively slidable state.

### TECHNICAL FIELD

The present disclosure relates to the technical field of photography apparatus, and in particular to a leg of a photography support apparatus and a photography support apparatus using the leg.

### BACKGROUND

Tripod is a commonly used support apparatus in photography, videography, and surveying. It provides stable support by extending or retracting its leg sections to adjust the height or adapt ground environment. The design of the leg locking and unlocking mechanisms is central to its functionality, directly impacting operational efficiency and user experience.

In related art, leg adjustment of the tripod typically relies on independent locking mechanisms for each leg section, such as knob-type, lever-type, or snap-fit mechanisms. The knob-type mechanism secures the leg tube through rotating and pressing it; the lever-type mechanism clamps the leg tube via flipping it; and the snap-fit mechanism employs a spring-loaded pin to engage in holes of the leg tube to lock the leg tube. To unlock, the reverse operation is performed, allowing the leg tubes to slide freely for length adjustment.

However, the aforementioned adjustment methods in the related art involve cumbersome operations, with low efficiency due to section-by-section adjustment. This is particularly inconvenient during rapid shooting scene changes, leading to poor operational convenience.

### SUMMARY

The present disclosure provides a leg of a photography support apparatus and a photography support apparatus using the leg, aiming to enhance the operation convenience of the leg of the photography support apparatus.

To realize the above objective, the present disclosure provides a leg of a photography support apparatus. The photography support apparatus includes a mounting device for connecting a photography device. The leg is connected to the mounting device. The leg includes a plurality of sequentially nested tubular members, with a locking mechanism provided between any two adjacent tubular members; and a driving mechanism drivingly connected to each of the locking mechanisms. The driving mechanism is configured to drive each of the locking mechanisms, to allow any two adjacent tubular members to be in either a relatively fixed state or a relatively slidable state.

In some embodiments, the plurality of sequentially nested tubular members at least includes a first tubular member, a second tubular member slidably disposed within the first tubular member, and a third tubular member slidably disposed within the second tubular member. The locking mechanisms includes a first locking mechanism configured for configuring the first tubular member and the second tubular member in either the relatively fixed state or the relatively slidable state, and a second locking mechanism configured for configuring the second tubular member and the third tubular member in either the relatively fixed state or the relatively slidable state.

In some embodiments, the first locking mechanism includes a ferrule component nested on the second tubular member and a locking ferrule component nested on the first tubular member and drivingly connected to the driving mechanism. The ferrule component is defined with a contractible clamping mouth portion. The locking ferrule component is provided with an abutting portion for cooperating with the clamping mouth portion. The driving mechanism is configured to drive the locking ferrule component to move, to allow the abutting portion to abut against or move away from the clamping mouth portion, so as to configure the first tubular member and the second tubular member either in the relatively fixed state or the relatively slidable state.

In some embodiments, the locking ferrule component includes a locking sleeve member nested on the ferrule component. A first space is defined between the locking sleeve member and the ferrule component, a second space is defined between the locking sleeve member and the first tubular member, and the first space is communicated with the second space. The locking ferrule component is disposed in the second space, and the driving mechanism is configured to drive the abutting portion of the locking ferrule component to enter or leave the first space to abut against or move away from the clamping mouth portion, to configure the first tubular member and the second tubular member in either the relatively fixed state or the relatively slidable state.

In some embodiments, the locking sleeve member includes an inner wall provided with an internal thread. The first tubular member includes a first sub-tubular member and a second sub-tubular member. The second sub-tubular member is slidably disposed within the first sub-tubular member and drivingly connected to the driving mechanism, and at least a portion of the second sub-tubular member is exposed from the first sub-tubular member. The locking ferrule component further includes an intermediate member and an adapter member. An end of the intermediate member is located between the locking sleeve member and the first sub-tubular member and nested on the first sub-tubular member; a middle portion of the intermediate member is located between the second sub-tubular member and the locking sleeve member; and the other end of the intermediate member is provided with the abutting portion and located between the second tubular member and the locking sleeve member. The adapter member is on the middle portion of the intermediate member and threadedly connected to the locking sleeve member. The driving mechanism is configured to drive the second sub-tubular member to slide relative to the first sub-tubular member, to allow the abutting portion to move along with the intermediate member to abut against or move away from the clamping mouth portion.

In some embodiments, the locking ferrule component further includes an abutting member threadedly connected to the intermediate member and located between the ferrule component and the intermediate member. The abutting member is provided with the abutting portion, and the abutting portion engages with the clamping mouth portion via a wedge fit.

In some embodiments, the leg further includes a transmission mechanism. The transmission mechanism includes a first mounting member mounted to the first sub-tubular member, a first bolt including an end rotatably mounted to the first mounting member, a second mounting member mounted to the second sub-tubular member and threadedly connected to the other end of the first bolt, and a transmission rod. The transmission rod includes an end drivingly connected to the driving mechanism and another end connected to the first bolt. The transmission rod is configured to be driven by the driving mechanism to move the first bolt, to allow the second mounting member to drive the second sub-tubular member to slide relative to the first sub-tubular member, so as to allow the intermediate member to drive the abutting portion to abut against or move away from the clamping mouth portion.

In some embodiments, the second tubular member includes a third sub-tubular member and a fourth sub-tubular member slidably disposed within the third sub-tubular member. The third tubular member is slidably disposed within the fourth sub-tubular member. The transmission mechanism further includes a third mounting member mounted to the third sub-tubular member, a second bolt having an end rotatably mounted to the third mounting member, and a fourth mounting member mounted to the fourth sub-tubular member and threadedly connected to the other end of the second bolt. The transmission rod passes through the first bolt and the second bolt, and the transmission rod is configured to drive the first bolt and the second bolt to move, to allow the first locking mechanism and the second locking mechanism to be actuated simultaneously, so as to configure the first tubular member and the second tubular member in either the relatively fixed state or the relatively slidable state, and configure the second tubular member and the third tubular member in either the relatively fixed state or the relatively slidable state.

In some embodiments, the leg further includes a mounting mechanism connected to the mounting device and disposed at an end of the first tubular member away from the second tubular member. The driving mechanism includes a rotating member connected to the transmission rod, and a handle member connected to the rotating member. The handle member is configured to be driven by an external force to allow the rotating member to drive the transmission rod to rotate.

The present disclosure further provides a photography support apparatus, including a mounting device and a plurality of legs of any one of the foregoing embodiments. The plurality of legs is connected to the mounting device, and the mounting device is configured to mount a photography device.

According to the present disclosure, a plurality of sequentially nested tubular members are provided as the retractable support structure of the leg, with a locking mechanism arranged between any two adjacent tubular members. A driving mechanism is configured to uniformly control the locking mechanisms. The driving mechanism is connected to each locking mechanism, and by actuating the driving mechanism (either through an external force applied to the driving mechanism or by an internal power source), the locking mechanisms are activated, thereby synchronously adjusting the locked or unlocked state of all the tubular members. Unlike the conventional approach of individually locking each section, the present disclosure utilizes a centralized transmission mechanism to enhance operational convenience. This enables the plurality of sequentially nested tubular members to switch between a relatively fixed state and a relatively slidable state, making the adjustment convenient, quick, and highly operable.

### BRIEF DESCRIPTION OF THE DRAWINGS

FIG. 1 is a structural schematic diagram showing a leg of a photography support apparatus according to an embodiment of the present disclosure.

FIG. 2 is another structural schematic diagram showing a leg of a photography support apparatus according to an embodiment of the present disclosure.

FIG. 3 is a cross-sectional view of the leg in FIG. 2 taken along line A-A.

FIG. 4 is an enlarged view of portion B in FIG. 3.

FIG. 5 is a structural schematic diagram showing a first locking mechanism of a leg according to an embodiment of the present disclosure.

FIG. 6 is an enlarged view of portion C in FIG. 3.

FIG. 7 is a structural schematic diagram showing part of a driving mechanism and a transmission mechanism of a leg according to an embodiment of the present disclosure.

FIG. 8 is a schematic diagram showing of a photography support apparatus with a photography device mounted thereon according to an embodiment of the present disclosure.

The realization of the objectives, functional features, and advantages of the present disclosure will be further described in conjunction with the embodiments and with reference to the accompanying drawings.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

It should be noted that all directional indications (such as up, down, left, right, front, back) in the embodiments of the present disclosure are merely used to explain relative position relationships or motion conditions between the components in a specific attitude (as shown in the drawings). The directional indication changes as the specific attitude changes.

It should also be noted that when an element is referred to as being “mounted on” or “disposed on” another element, it may be directly on the other element, or intervening elements may also be present. When an element is referred to as being “connected to” another element, it may be directly connected to the other element, or intervening elements may also be present.

Moreover, the terms “first”, “second”, and the like in the present disclosure are merely used for description and cannot be understood as indicating or implying their relative importance or as implicitly indicating the quantity of the technical features indicated. Thus, the feature defined by “first” or “second” may explicitly or implicitly include at least one such feature. In addition, the technical solutions of various embodiments may be combined with each other, but must be based on that the combined technical solutions can be implemented by those skilled in the art. When the combination of the technical solutions is contradictory or impossible to realize, it shall be considered that such combination does not exist and is not within the scope of protection of the present disclosure.

The present disclosure is applicable to photography support apparatuses, such as tripods. Such photography support apparatus typically includes a mounting device configured to connect to a photography device, and legs connected to the mounting device and configured to support the mounting device on the ground.

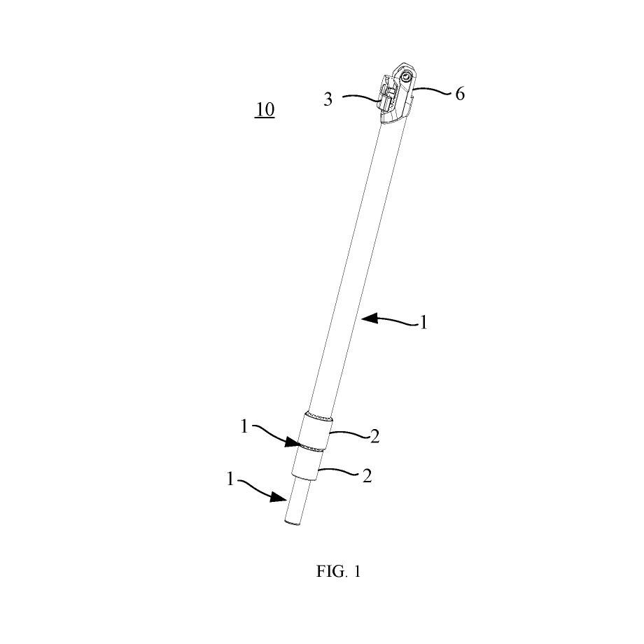

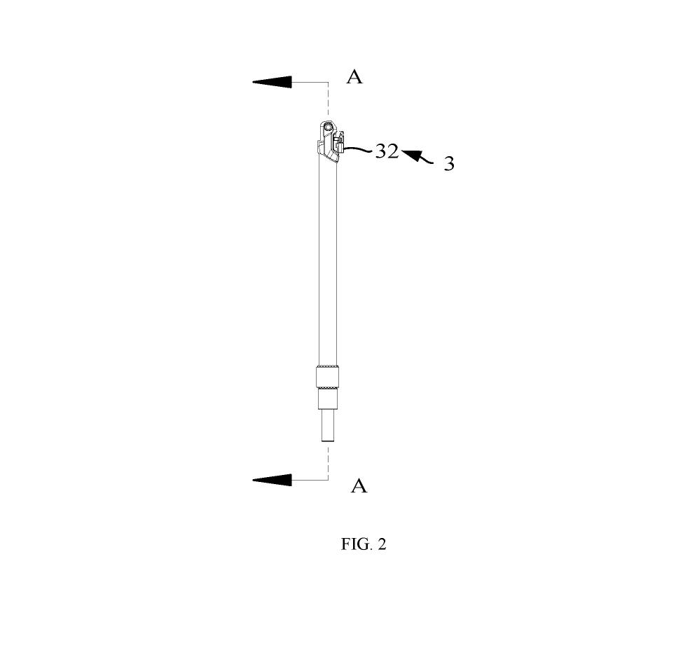

With reference to FIGS. 1 and 2, in order to improve the operational convenience of the leg of the photography support apparatus, the present disclosure provides a leg 10 for a photography support apparatus, and the leg 10 includes:
a plurality of sequentially nested tubular members 1, with a locking mechanism 2 provided between any two adjacent tubular members 1; and
a driving mechanism 3 drivingly connected to each locking mechanism 2, the driving mechanism 3 being configured to drive each locking mechanism 2, to allow any two adjacent tubular members 1 to be in either a relatively fixed state or a relatively slidable state.

In the embodiments, the present disclosure provides a leg 10 for a photography support apparatus. A single driving mechanism 3 is used to uniformly control all the locking mechanisms 2, enabling the plurality of sequentially nested tubular members 1 (i.e., the telescopic sections of the leg 10) to switch between the relatively fixed state and the relatively slidable state. The driving mechanism 3 is drivingly connected to all the locking mechanisms 2, to convert the user’s operation into motions of all the locking mechanisms 2, thereby synchronously adjusting the locked or unlocked state of all the tubular members 1. Unlike conventional approaches that require individual locking of each tubular member, the leg provided herein employs a centralized transmission mechanism to enhance operation convenience.

The leg 10 includes the plurality of sequentially nested tubular members 1, the locking mechanisms 2 are disposed between any two adjacent tubular members 1, and the driving mechanism 3 is drivingly connected to all the locking mechanisms 2. The user can operate the driving mechanism 3 (which may be, for example, a rotary handle, a pressing mechanism, etc., provided herein merely for illustrative purposes), such that the driving mechanism 3 transmits the operation to each locking mechanism 2 via a drive transmission means (such as a threaded connection, hydraulic pressure, or a linkage rod, also provided herein merely for illustrative purposes). Each locking mechanism 2 applies force to two adjacent tubular members 1 connected to the locking mechanism 2, such that all adjacent pairs of tubular members 1 are fixed in a non-slidable state relative to each other, thereby completing the locking of the entire leg length. To unlock, the user operates the driving mechanism 3 in the reverse direction, and each locking mechanism 2 releases the applied force, such that the two adjacent tubular members 1 connected to the locking mechanism 2 return to the relatively slidable state, allowing the user to freely adjust the length of the leg 10. Driven by the single driving mechanism 3, all the locking mechanisms 2 are actuated simultaneously, thereby synchronously locking or unlocking the plurality of tubular members 1.

The leg 10 of the photography support apparatus according to the present disclosure, with a single driving mechanism 3 controlling all the locking mechanisms 2, user can lock or unlock the leg 10 with just one operation, significantly reducing adjustment time. It is particularly suitable for photography scenarios that require frequent height adjustments, greatly improving user experience.

In summary, through the cooperative transmission between the driving mechanism 3 and the locking mechanisms 2, the present disclosure achieves centralized control of the plurality of tubular members of the leg. Its operation process is simplified so that the user can synchronously lock or unlock the leg 10 by operating the driving mechanism 3, thereby achieving significant improvements in operational efficiency, stability, and practicality, and overcoming the drawbacks associated with cumbersome adjustments in conventional tripods.

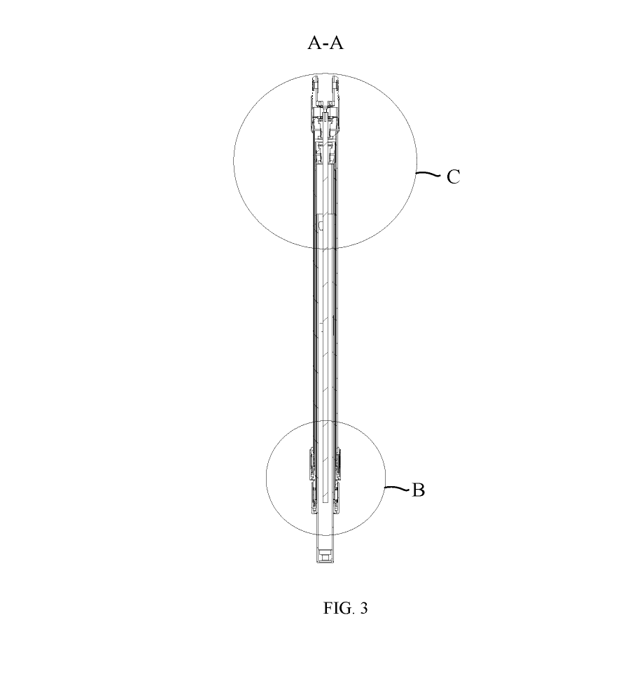

In some embodiments, with reference to FIGS. 1-4, the plurality of sequentially nested tubular members 1 at least include a first tubular member 11, a second tubular member 12 slidably disposed within the first tubular member 11, and a third tubular member 13 slidably disposed within the second tubular member 12. The locking mechanism 2 includes a first locking mechanism 21 for configuring the first tubular member 11 and the second tubular member 12 in either the relatively fixed state or the relatively slidable state, and further includes a second locking mechanism 22 for configuring the second tubular member 12 and the third tubular member 13 in either the relatively fixed state or the relatively slidable state.

In the embodiments, the plurality of tubular members 1, which are telescopically engaged with one another, at least includes the first tubular member 11, the second tubular member 12 slidably disposed within the first tubular member 11, and the third tubular member 13 slidably disposed within the second tubular member 12. The locking mechanism 2 includes the first locking mechanism 21 and the second locking mechanism 22, responsible for controlling the relative sate (fixed or slidable) between the first tubular member 11 and the second tubular member 12, and between the second tubular member 12 and the third tubular member 13. The driving mechanism 3 is drivingly connected to both the first locking mechanism 21 and the second locking mechanism 22 to uniformly actuate the first locking mechanism 21 and the second locking mechanism 22, thereby enabling overall adjustment of the leg 10. In some embodiments, the third tubular member 13 is a foot tube for supporting on the ground.

The user can operate the driving mechanism 3 (e.g., rotating handle or pressing the mechanism), which transmits the motion to the first locking mechanism 21 and the second locking mechanism 22 via a transmission system (which may be threads, a linkage rod, or a hydraulic system). The first locking mechanism 21 is driven to apply force, to fix the first tubular member 11 and the second tubular member 12 in a non-slidable state. Simultaneously, the second locking mechanism 22 is driven to apply force to fix the second tubular member 12 and the third tubular member 13 in a non-slidable state. The two-stage locking mechanisms are actuated synchronously, so that the entire leg 10 is locked at a predetermined length.

In the embodiments, the driving mechanism 3 synchronously drives the first locking mechanism 21 and the second locking mechanism 22 to control the state switching of the three-stage sequentially nested tubular members (i.e., the first tubular member 11, the second tubular member 12, and the third tubular member 13). This enables synchronized locking or unlocking of the two-stage locking mechanisms via a single operation.

In some embodiments, with reference to FIGS. 1-5, the first locking mechanism 21 includes a ferrule component 211 and a locking ferrule component 212.

The ferrule component 211 is nested on the second tubular member 12 and defined with a contractible clamping mouth portion 2110.

The locking ferrule component 212 is nested on the first tubular member 11 and drivingly connected to the driving mechanism 3. The locking ferrule component 212 is provided with an abutting portion 2120 for cooperating with the clamping mouth portion 2110.

The driving mechanism 3 is configured to drive the locking ferrule component 212 to move, so as to allow the abutting portion 2120 to abut against or move away from the clamping mouth portion 2110, thereby configuring the first tubular member 11 and the second tubular member 12 in either the relatively fixed state or the relatively slidable state.

In the embodiments, the first locking mechanism 21 achieves locking or unlocking of the first tubular member 11 and the second tubular member 12 through a cooperation between the ferrule component 211 and the locking ferrule component 212. The ferrule component 211 is nested on the second tubular member 12 and has a contractible clamping mouth portion 2110, which is configured to clamp or release the second tubular member 12 under an external force. The locking ferrule component 212 is nested on the first tubular member 11 and is drivingly connected to the driving mechanism 3, with its abutting portion 2120 cooperating with the clamping mouth portion 2110. The driving mechanism 3 drives the locking ferrule component 212 to move, causing the abutting portion 2120 to abut against or move away from the clamping mouth portion 2110, thereby controlling the contracted or released state of the ferrule component 211, and consequently locking or unlocking the first tubular member 11 and the second tubular member 12. This process is based on the synergistic effect of mechanical transmission and compressive deformation.

In an initial state, the ferrule component 211 is nested on the second tubular member 12, with its clamping mouth portion 2110 in a non-contracted state; the locking ferrule component 212 is nested on the first tubular member 11, with its abutting portion 2120 close to the clamping mouth portion 2110 but without exerting pressure on the clamping mouth portion 2110.

The user can operate the driving mechanism 3 (e.g., by rotating or pushing), which drives the locking ferrule component 212 to move in a predetermined direction via a transmission (such as a threads or a linkage rod). The abutting portion 2120 of the locking ferrule component 212 gradually approaches and abuts against the clamping mouth portion 2110, applying an external force to contract the clamping mouth portion 2110. After the clamping mouth portion 2110 is contracted, the clamping mouth portion 2110 clamps the second tubular member 12, which increases the frictional force or mechanical clamping force between the first tubular member 11 and the second tubular member 12, thereby fixing the first tubular member 11 and the second tubular member 12 in the relatively non-slidable state.

In the embodiments, the cooperative action between the abutting portion 2120 and the clamping mouth portion 2110 enables efficient fixation of the second tubular member 12 through simple motion, achieving quick operation. Further, the arrangement of the ferrule component 211 and the locking ferrule component 212 involves fewer components and provides direct transmission.

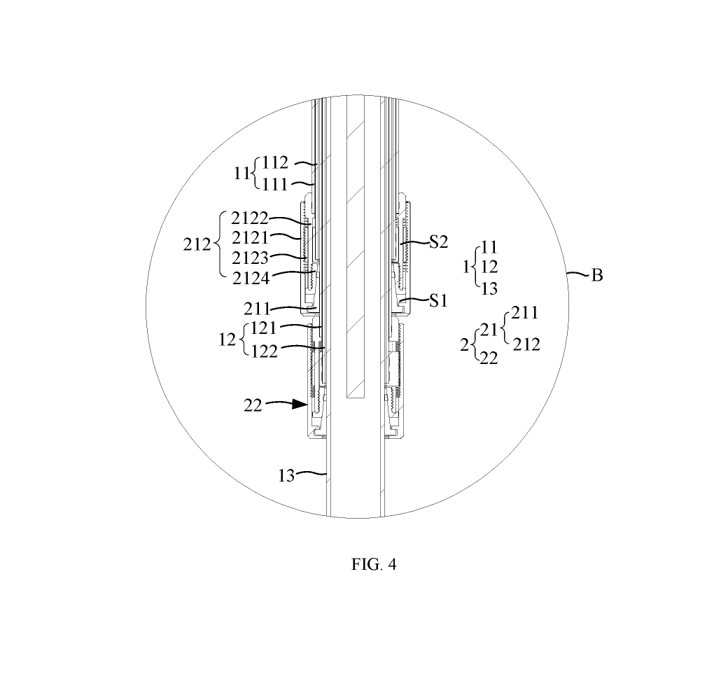

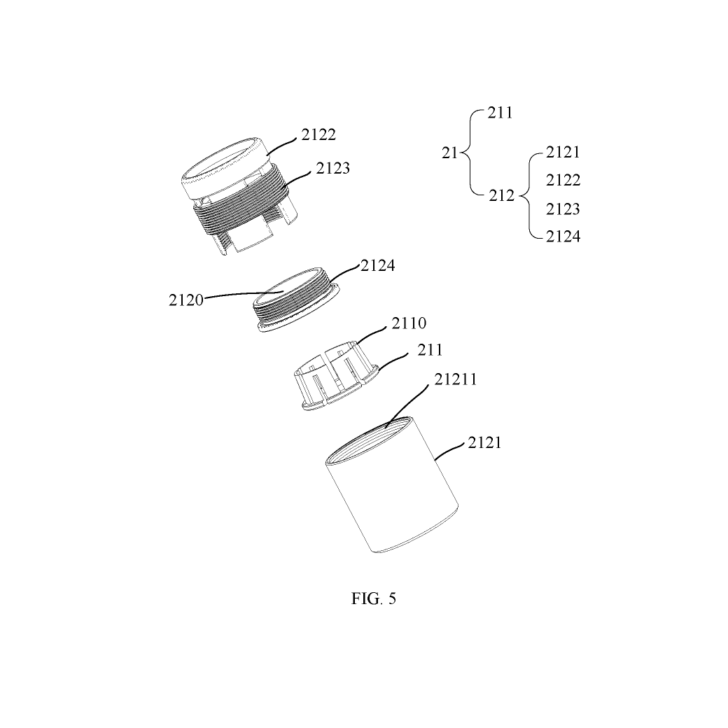

In some embodiments, with reference to FIGS. 4 and 5, the locking ferrule component 212 further includes a locking sleeve member 2121 nested on the ferrule component 211.

A first space S1 is defined between the locking sleeve member 2121 and the clamping mouth portion 2110, and a second space S2 is defined between the locking sleeve member 2121 and the first tubular member 11. The first space S1 is communicated with the second space S2.

The locking ferrule component 212 is disposed within the second space S2. The driving mechanism 3 is configured to drive the abutting portion 2120 to enter or leave the first space S1, so as to abut against or move away from the clamping mouth portion 2110, thereby configuring the first tubular member 11 and the second tubular member 12 in either the relatively fixed state or the relatively slidable state.

In the embodiments, the locking sleeve member 2121 is nested on the ferrule component 211. The first space S1 is defined between the locking sleeve member 2121 and the clamping mouth portion 2110 of the ferrule component 211, and the second space S2 is defined between the locking sleeve member 2121 and the first tubular member 11. The first space S1 and the second space S2 are communicated with each other. The clamping mouth portion 2110 is contractible. The locking ferrule component 212 is at least partially located in the second space S2, and its abutting portion 2120 is capable of entering or leaving the first space S1 driven by the driving mechanism 3, so as to abut against or move away from the clamping mouth portion 2110. When the abutting portion 2120 extends into the first space S1 and abuts against the clamping mouth portion 2110, the ferrule component 211 is contracted to clamp the second tubular member 12, thereby fixing the first tubular member 11 and the second tubular member 12 relative to each other. When the abutting portion 2120 moves away from the clamping mouth portion 2110, the clamping mouth portion 2110 releases the second tubular member 12, such that the first tubular member 11 and the second tubular member 12 are released from the relatively fixed state.

In the initial state, the locking sleeve member 2121 is nested on the ferrule component 211, the abutting portion 2120 is not yet in abutment with the clamping mouth portion 2110, and the ferrule component 211 is in a relaxed state. The user can operate the driving mechanism 3 (e.g., by rotating or pushing), such that the driving mechanism 3 drives the locking ferrule component 212 to move via a transmission (such as a threaded mechanism or a linkage rod). The abutting portion 2120 of the locking ferrule component 212 extends into the first space S1, gradually approaching and abutting against the clamping mouth portion 2110. The clamping mouth portion 2110 is contracted under compression, to squeeze the second tubular member 12. This generates sufficient friction or clamping force between the first tubular member 11 and the second tubular member 12, allowing the first tubular member 11 and the second tubular member 12 to be in the relatively fixed state.

In the embodiments, the driving mechanism 3 controls the abutting portion 2120 of the locking ferrule component 212 to move between the first space S1 and the second space S2, so as to abut against or move away from the clamping mouth portion 2110, thereby adjusting the contracted state of the ferrule component 211. The process achieves contraction or relaxation of the clamping mouth portion through spatial movement, thereby effectuating locking or unlocking of the tubular members of the leg 10.

In some embodiments, referring to FIGS. 4 and 5, the locking sleeve member 2121 has an inner wall provided with an internal thread 21211. The first tubular member 11 includes a first sub-tubular member 111 and a second sub-tubular member 112. The second sub-tubular member 112 is slidably disposed within the first sub-tubular member 111 and drivingly connected to the driving mechanism 3. At least a portion of the second sub-tubular member 112 is exposed from the first sub-tubular member 111. The locking ferrule component 212 further includes an intermediate member 2122 and an adapter member 2123.

An end of the intermediate member 2122 is located between the locking sleeve member 2121 and the first sub-tubular member 111 and nested on the first sub-tubular member 111. A middle portion of the intermediate member 2122 is located between the second sub-tubular member 112 and the locking sleeve member 2121. The other end of the intermediate member 2122 is provided with the abutting portion 2120 and located between the second tubular member 12 and the locking sleeve member 2121.

The adapter member 2123 is nested on the middle portion of the intermediate member 2122 and threadedly connected to the locking sleeve member 2121.

The driving mechanism 3 drives the second sub-tubular member 112 to slide relative to the first sub-tubular member 111, so that the intermediate member 2122 drives the abutting portion 2120 to abut against or move away from the clamping mouth portion 2110.

In the embodiments, the first tubular member 11 includes the first sub-tubular member 111 and the second sub-tubular member 112. The second sub-tubular member 112 is slidably disposed within the first sub-tubular member 111 and is drivingly connected to the driving mechanism 3. The locking ferrule component 212 further includes the intermediate member 2122 and the adapter member 2123. The intermediate member 2122 is nested on the first sub-tubular member 111, and the abutting portion 2120 is located between the second tubular member 12 and the locking sleeve member 2121. The adapter member 2123 is threadedly connected to the internal thread 21211 of the locking sleeve member 2121. The driving mechanism 3 drives the second sub-tubular member 112 to slide, which in turns drives the intermediate member 2122 to move, allowing the abutting portion 2120 to abut against or move away from the clamping mouth portion 2110 of the ferrule component 211, thereby controlling the contracted state of the clamping mouth portion 2110, and consequently, achieving relative fixation or relative sliding between the first tubular member 11 and the second tubular member 12. The above process is based on the sliding motion being converted into displacement of the abutting portion 2120 through threaded transmission, which indirectly adjusts the clamping effect on the clamping mouth portion 2110.

The locking sleeve member 2121 is nested on the ferrule component 211 and has an internal thread 21211 on its inner wall. The second sub-tubular member 112 is nested in the first sub-tubular member 111 and is partially exposed. The second sub-tubular member 112 is connected to the driving mechanism 3. The intermediate member 2122 is nested on the first sub-tubular member 111. One end of intermediate member 2122 is located between the locking sleeve member 2121 and the first sub-tubular member 111, and the middle portion of the intermediate member 2122 is threadedly connected to the locking sleeve member 2121 via the adapter member 2123. The abutting portion 2120 is located between the second tubular member 12 and the locking sleeve member 2121, and is not yet abutted against the clamping mouth portion 2110.

The user can operate the driving mechanism 3 (e.g., by rotating or pushing) to drive the second sub-tubular member 112 to slide relative to the first sub-tubular member 111. The sliding of the second sub-tubular member 112 drives the entire intermediate member 2122 to move. Since the adapter member 2123 is threadedly connected to the internal thread 21211 of the locking sleeve member 2121, the movement of the intermediate member 2122 is constrained and guided by the threaded connection between the adapter member 2123 and the locking sleeve member 2121. The abutting portion 2120 gradually approaches and abuts against the clamping mouth portion 2110 along the axial direction of the first tubular member 11, applying pressure to contract the clamping mouth portion 2110. After contraction, the clamping mouth portion 2110 clamps the second tubular member 12, thereby fixing the first tubular member 11 and the second tubular member 12 in the relatively non-slidable state.

In the embodiments, the driving mechanism 3 drives the second sub-tubular member 112 to slide. Through the threaded engagement between the intermediate member 2122 and the adapter member 2123, the sliding motion is transformed into the abutment or disengagement of the abutting portion 2120 relative to the clamping mouth portion 2110, thereby controlling the state of the first tubular member 11 and the second tubular member 12. This process involves coordinated actions of sliding actuation, threaded guidance, and clamping mouth portion contraction, achieving a precise, efficient, and stable locking function. It provides an alternative mechanical solution for adjusting the leg.

In some embodiments, referring to FIGS. 4 and 5, the locking ferrule component 212 further includes an abutting member 2124, which is threadedly connected to the intermediate member 2122 and located between the ferrule component 211 and the intermediate member 2122. The abutting member 2124 is provided with the abutting portion 2120. The abutting portion 2120 engages with the clamping mouth portion 2110 via a wedge fit.

In the embodiments, the abutting member 2124 is rotatably connected to the intermediate member 2122 via a threaded connection, and is located between the ferrule component 211 and the intermediate member 2122. The abutting member 2124 is provided with the abutting portion 2120. The abutting portion 2120 engages with the clamping mouth portion 2110 of the ferrule component 211 via a wedge fit. The driving mechanism 3 drives the second sub-tubular member 112 to slide, which in turns drives the intermediate member 2122 to move, thereby causing the abutting member 2124 to rotate. This allows the wedge surface of the abutting portion 2120 to abut against or move away from the wedge surface of the clamping mouth portion 2110, controlling the contracted state of the clamping mouth portion 2110, thereby realizing relative fixation or relative sliding between the first tubular member 11 and the second tubular member 12. This process is based on combined transmission of sliding motion through rotation and wedge surface compression, which enhances both the precision and the clamping force of the locking function.

It will be appreciated that the abutting member 2124 is individually provided from the intermediate member 2122 as described in the embodiments, or is integrally provided with the intermediate member 2122 as in some other embodiments, which is not limited herein.

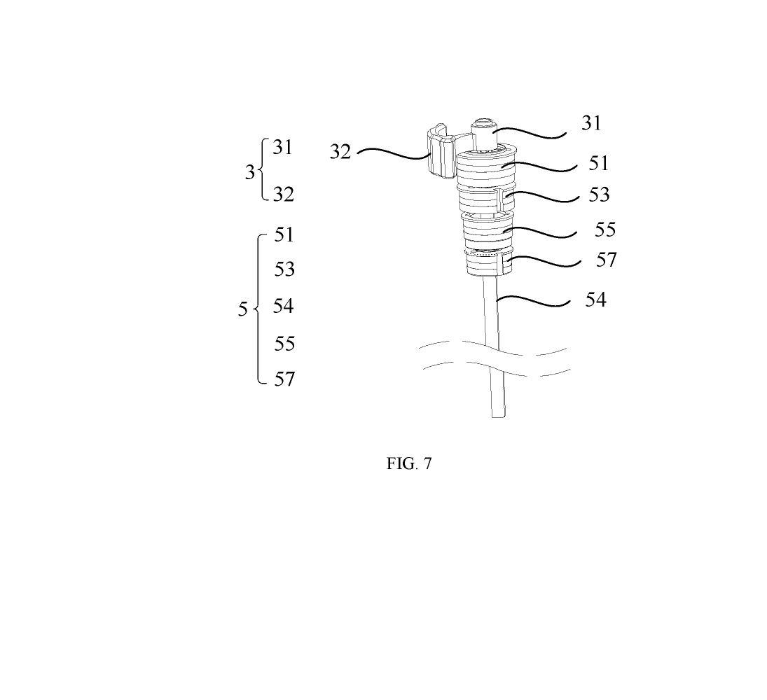

In some embodiments, referring to FIGS. 4-7, the leg 10 further includes a transmission mechanism 5. The transmission mechanism 5 includes:
a first mounting member 51 mounted to the first sub-tubular member 111;
a first bolt 52 having an end rotatably mounted to the first mounting member 51;
a second mounting member 53 mounted to the second sub-tubular member 112, the second mounting member 53 being threadedly connected to the other end of the first bolt 52; and
a transmission rod 54 having an end drivingly connected to the driving mechanism 3 and the other end connected to the first bolt 52, the transmission rod 54 being configured to be driven by the driving mechanism 3 to move the first bolt 52, to allow the second mounting member 53 to drive the second sub-tubular member 112 to slide relative to the first sub-tubular member 111, so as to allow the intermediate member 2122 to drive the abutting portion 2120 to abut against or move away from the clamping mouth portion 2110.

In the embodiments, the leg 10 further includes the transmission mechanism 5 for transmitting motion of the driving mechanism 3 to the first locking mechanism 21, achieving locking or unlocking of the first tubular member 11 and the second tubular member 12. The transmission mechanism 5 includes the first mounting member 51 (mounted to the first sub-tubular member 111), the first bolt 52 (having one end rotatably connected to the first mounting member 51 and the other end threadedly connected to the second mounting member 53), the second mounting member 53 (mounted to the second sub-tubular member 112), and the transmission rod 54 (connecting the driving mechanism 3 and the first bolt 52). The driving mechanism 3 drives the first bolt 52 to rotate via the transmission rod 54. Through threaded engagement, the second mounting member 53 is driven to slide the second sub-tubular member 112 relative to the first sub-tubular member 111. As a result, the intermediate member 2122 is pushed to move, such that the abutting portion 2120 either abuts against or moves away from the clamping mouth portion 2110, thereby controlling the contracted state of the clamping mouth portion 2110. This process is based on the conversion of rotational motion into linear sliding through threaded transmission, which indirectly adjusts the locking state.

In the embodiments, the transmission mechanism 5 converts the motion of the driving mechanism 3 into linear sliding of the second sub-tubular member 112 via the transmission rod 54 and the first bolt 52, allowing a single operation by the user to complete locking or unlocking with high efficiency.

Further, the transmission mechanism 5 integrates the complex sliding action into a single actuation of the driving mechanism 3, providing an intuitive and convenient operation for the user and reducing the difficulty of use.

In the embodiments, the transmission rod 54 drives the first bolt 52 to rotate, and through threaded engagement, drives the second sub-tubular member 112 to slide, thereby driving the intermediate member 2122 and the abutting portion 2120 to adjust the contracted state of the clamping mouth portion 2110. This process involves sequential operations of rotation, threaded transmission, and abutting compression, achieving an efficient, precise, and stable locking function. It provides a reliable transmission solution for adjusting the leg.

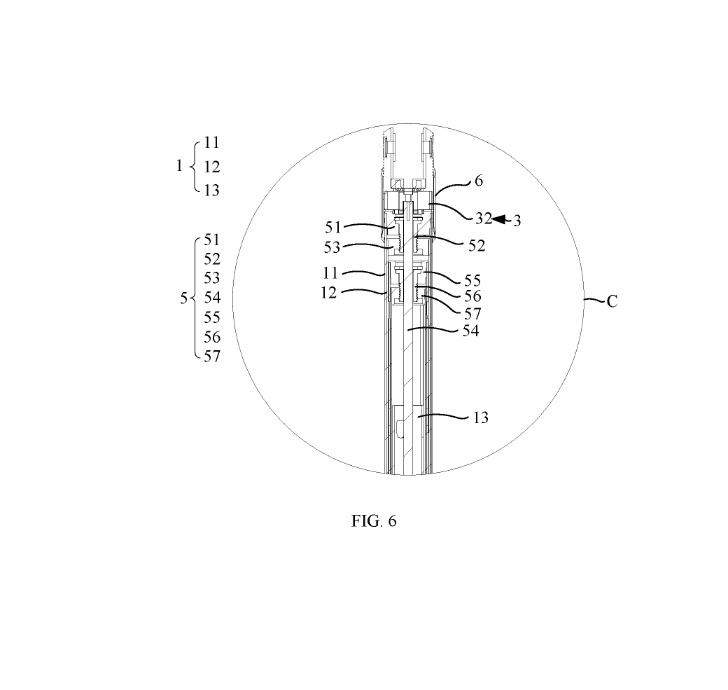

In some embodiments, referring to FIGS. 4 and 6, the second locking mechanism 22 has the similar structure as the first locking mechanism 21. The second tubular member 12 includes a third sub-tubular member 121 and a fourth sub-tubular member 122 slidably disposed within the third sub-tubular member 121. The third tubular member 13 is slidably disposed within the fourth sub-tubular member 122. The transmission mechanism 5 further includes:
a third mounting member 55 mounted to the third sub-tubular member 121;
a second bolt 56 having one end rotatably mounted to the third mounting member 55; and
a fourth mounting member 57 mounted to the fourth sub-tubular member 122, the fourth mounting member 57 being threadedly connected to the other end of the second bolt 56.

The transmission rod 54 passes through the first bolt 52 and the second bolt 56, and is configured to drive the first bolt 52 and the second bolt 56 to move, such that the first locking mechanism 21 and the second locking mechanism 22 are actuated simultaneously, thereby configuring the first tubular member 11 and the second tubular member 12 in either the relatively fixed state or the relatively slidable state, and configuring the second tubular member 12 and the third tubular member 13 in either the relatively fixed state or the relatively slidable state.

In the embodiments, the second tubular member 12 is a double-layered tubular member similar to the first tubular member 11. The locking mechanism 2 includes the first locking mechanism 21 and the second locking mechanism 22, and the second locking mechanism 22 has the same structure as the first locking mechanism 21. The first locking mechanism 21 is configured to control the relative state between the first tubular member 11 and the second tubular member 12, and the second locking mechanism 22 is configured to control the relative state between the second tubular member 12 and the third tubular member 13. The transmission mechanism 5, which is configured to simultaneously drive the first locking mechanism 21 and the second locking mechanism 22, includes the first bolt 52 (connecting the first sub-tubular member 111 and the second sub-tubular member 112), the second bolt 56 (connecting the third sub-tubular member 121 and the fourth sub-tubular member 122), and the transmission rod 54 passed through the two bolts. The driving mechanism 3 simultaneously drives the first bolt 52 and the second bolt 56 to rotate via the transmission rod 54, and through threaded engagement, drives the second sub-tubular member 112 and the fourth sub-tubular member 122 to slide, thereby driving the intermediate member 2122 and the abutting portion 2120 of the respective connected locking mechanisms to move. This achieves synchronous adjustment of the contraction states of the clamping mouth portions 2110 of the two locking mechanisms, thereby achieving unified locking or unlocking of the multi-stage tubular members 1.

In some embodiments, the first mounting member 51, the second mounting member 53, the third mounting member 55, and the fourth mounting member 57 are bearing seats; the transmission rod 54 is a square rod; the first bolt 52 and the second bolt 56 are defined with square holes adapted to the square rod, such that rotation of the transmission rod 54 can drive the first bolt 52 and the second bolt 56 to rotate. The first bolt 52 drives the second mounting member 53, which is threadedly engaged therewith, to move linearly relative to the first mounting member 51; the second bolt 56 drives the fourth mounting member 57, which is threadedly engaged therewith, to move linearly relative to the third mounting member 55.

In some embodiments, with reference to FIG. 6, the leg further includes a mounting mechanism 6 configured to connect to a mounting device 20. The mounting mechanism 6 is disposed at an end of the first tubular member 11 away from the second tubular member 12. The driving mechanism 3 includes:
a rotating member 31 connected to the transmission rod 54; and
a handle member 32 connected to the rotating member 31 and configured to be driven by an external force to allow the rotating member 31 to drive the transmission rod 54 to rotate.

In the embodiments, the leg 10 further includes the mounting mechanism 6, and the driving mechanism 3 includes the rotating member and the handle member, achieving the adjustment function of the leg. The mounting mechanism 6 is disposed at the end of the first tubular member 11 away from the second tubular member 12, and is configured to connect to a mounting device 20 (e.g., a top platform of a tripod). The driving mechanism 3 includes the rotating member 31 and the handle member 32, the two of which can be individually provided or integrally provided. The rotating member 31 is rotatably disposed on the mounting mechanism 6 and connected to the transmission rod 54. The handle member 32 is connected to the rotating member 31 for receiving an external force from a user. By operating the handle member 32, the user drives the rotating member 31 to rotate, which in turn drives the transmission rod 54 to rotate. The transmission rod 54 further drives the locking mechanisms (such as the bolt and the intermediate member 2122 in the foregoing embodiments), ultimately controlling the locked or unlocked state between the respective tubular members.

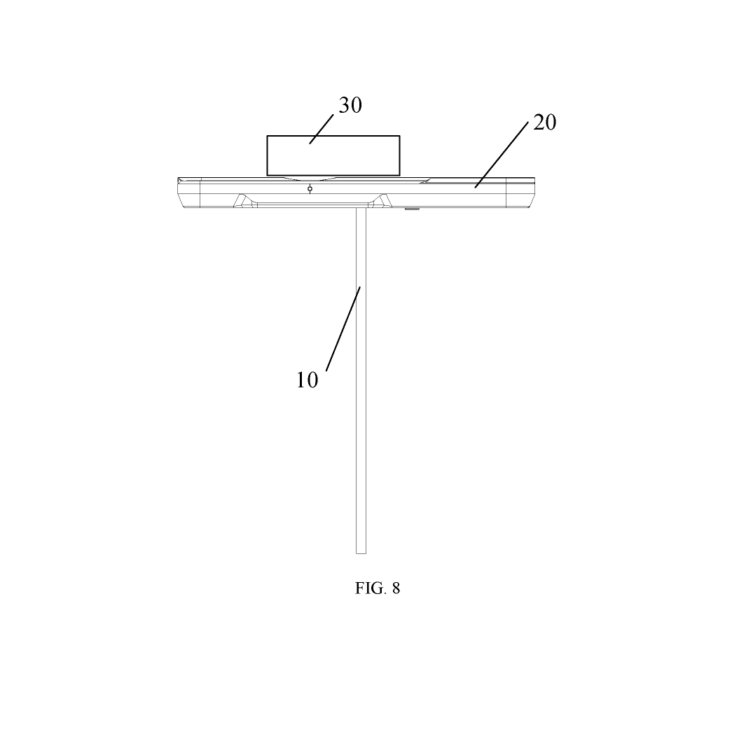

Referring to FIG. 8, the present disclosure further provide a photography support apparatus, including a mounting device 20 and a plurality of legs 10 as described in any of the foregoing embodiments. The plurality of legs 10 are connected to the mounting device 20. The mounting device 20 is configured to mount a photography device 30.

The above are only some embodiments of the present disclosure, and neither the words nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

What is claimed is:

1. A leg of a photography support apparatus, the photography support apparatus comprising a mounting device for connecting a photography device, the leg being connected to the mounting device, and the leg comprising:
a plurality of sequentially nested tubular members, with a locking mechanism provided between any two adjacent tubular members; and
a driving mechanism drivingly connected to each of the locking mechanisms, the driving mechanism being configured to drive each of the locking mechanisms, to allow any two adjacent tubular members to be in either a relatively fixed state or a relatively slidable state.

2. The leg of claim 1, wherein,
the plurality of sequentially nested tubular members at least comprise a first tubular member, a second tubular member slidably disposed within the first tubular member, and a third tubular member slidably disposed within the second tubular member; and
the locking mechanisms comprise a first locking mechanism for configuring the first tubular member and the second tubular member in either the relatively fixed state or the relatively slidable state, and a second locking mechanism for configuring the second tubular member and the third tubular member in either the relatively fixed state or the relatively slidable state.

3. The leg of claim 2, wherein the first locking mechanism comprises:
a ferrule component nested on the second tubular member, the ferrule component being defined with a contractible clamping mouth portion; and
a locking ferrule component nested on the first tubular member and drivingly connected to the driving mechanism, the locking ferrule component being provided with an abutting portion for cooperating with the clamping mouth portion;
wherein the driving mechanism is configured to drive the locking ferrule component to move, to allow the abutting portion to abut against or move away from the clamping mouth portion, so as to configure the first tubular member and the second tubular member either in the relatively fixed state or the relatively slidable state.

4. The leg of claim 3, wherein the locking ferrule component comprises:
a locking sleeve member nested on the ferrule component; wherein,
a first space is defined between the locking sleeve member and the ferrule component, a second space is defined between the locking sleeve member and the first tubular member, and the first space is communicated with the second space; and
the locking ferrule component is disposed in the second space, and the driving mechanism is configured to drive the abutting portion of the locking ferrule component to enter or leave the first space to abut against or move away from the clamping mouth portion, so as to configure the first tubular member and the second tubular member in either the relatively fixed state or the relatively slidable state.

5. The leg of claim 4, wherein,
the locking sleeve member comprises an inner wall provided with an internal thread;
the first tubular member comprises a first sub-tubular member and a second sub-tubular member, wherein the second sub-tubular member is slidably disposed within the first sub-tubular member and drivingly connected to the driving mechanism, and at least a portion of the second sub-tubular member is exposed from the first sub-tubular member; and
the locking ferrule component further comprises:
an intermediate member, an end of the intermediate member being located between the locking sleeve member and the first sub-tubular member and nested on the first sub-tubular member, a middle portion of the intermediate member being located between the second sub-tubular member and the locking sleeve member, and the other end of the intermediate member being provided with the abutting portion and located between the second tubular member and the locking sleeve member; and
an adapter member nested on the middle portion of the intermediate member and threadedly connected to the locking sleeve member;
wherein the driving mechanism is configured to drive the second sub-tubular member to slide relative to the first sub-tubular member, to allow the abutting portion to move along with the intermediate member to abut against or move away from the clamping mouth portion.

6. The leg of claim 5, wherein the locking ferrule component further comprises:
an abutting member threadedly connected to the intermediate member and located between the ferrule component and the intermediate member, the abutting member being provided with the abutting portion, and the abutting portion engaging with the clamping mouth portion via a wedge fit.

7. The leg of claim 5, further comprising:
a transmission mechanism, comprising:
a first mounting member mounted to the first sub-tubular member;
a first bolt, an end of the first bolt being rotatably mounted to the first mounting member;
a second mounting member mounted to the second sub-tubular member, the second mounting member being threadedly connected to the other end of the first bolt; and
a transmission rod comprising an end drivingly connected to the driving mechanism and another end connected to the first bolt, the transmission rod being configured to be driven by the driving mechanism to move the first bolt, to allow the second mounting member to drive the second sub-tubular member to slide relative to the first sub-tubular member, so as to allow the intermediate member to drive the abutting portion to abut against or move away from the clamping mouth portion.

8. The leg of claim 7, wherein the second tubular member comprises:
a third sub-tubular member and a fourth sub-tubular member slidably disposed within the third sub-tubular member, wherein the third tubular member is slidably disposed within the fourth sub-tubular member; and
the transmission mechanism further comprises:
a third mounting member mounted to the third sub-tubular member;
a second bolt, an end of the second bolt being rotatably mounted to the third mounting member; and
a fourth mounting member mounted to the fourth sub-tubular member, the fourth mounting member being threadedly connected to the other end of the second bolt;
wherein the transmission rod passes through the first bolt and the second bolt, and the transmission rod is configured to drive the first bolt and the second bolt to move, to allow the first locking mechanism and the second locking mechanism to be actuated simultaneously, so as to configure the first tubular member and the second tubular member in either the relatively fixed state or the relatively slidable state, and configure the second tubular member and the third tubular member in either the relatively fixed state or the relatively slidable state.

9. The leg of claim 8, further comprising:
a mounting mechanism connected to the mounting device, the mounting mechanism being disposed at an end of the first tubular member away from the second tubular member; and
the driving mechanism comprises:
a rotating member connected to the transmission rod; and
a handle member connected to the rotating member, the handle member being configured to be driven by an external force to allow the rotating member to drive the transmission rod to rotate.

10. A photography support apparatus, comprising a mounting device and a plurality of legs of claim 1, the plurality of legs being connected to the mounting device, and the mounting device being configured to mount a photography device.

11. The photography support apparatus of claim 10, wherein
the plurality of sequentially nested tubular members at least comprise a first tubular member, a second tubular member slidably disposed within the first tubular member, and a third tubular member slidably disposed within the second tubular member; and
the locking mechanisms comprise a first locking mechanism configured for configuring the first tubular member and the second tubular member in either the relatively fixed state or the relatively slidable state, and a second locking mechanism configured for configuring the second tubular member and the third tubular member in either the relatively fixed state or the relatively slidable state.

12. The photography support apparatus of claim 11, wherein the first locking mechanism comprises:
a ferrule component nested on the second tubular member, the ferrule component being defined with a contractible clamping mouth portion; and
a locking ferrule component nested on the first tubular member and drivingly connected to the driving mechanism, the locking ferrule component being provided with an abutting portion for cooperating with the clamping mouth portion;
wherein the driving mechanism is configured to drive the locking ferrule component to move, to allow the abutting portion to abut against or move away from the clamping mouth portion, so as to configure the first tubular member and the second tubular member either in the relatively fixed state or the relatively slidable state.

13. The photography support apparatus of claim 12, wherein the locking ferrule component comprises:
a locking sleeve member nested on the ferrule component; wherein,
a first space is defined between the locking sleeve member and the ferrule component, a second space is defined between the locking sleeve member and the first tubular member, and the first space is communicated with the second space; and
the locking ferrule component is disposed in the second space, and the driving mechanism is configured to drive the abutting portion of the locking ferrule component to enter or leave the first space to abut against or move away from the clamping mouth portion, to configure the first tubular member and the second tubular member in either the relatively fixed state or the relatively slidable state.

14. The photography support apparatus of claim 13, wherein,
the locking sleeve member comprises an inner wall provided with an internal thread;
the first tubular member comprises a first sub-tubular member and a second sub-tubular member, wherein the second sub-tubular member is slidably disposed within the first sub-tubular member and drivingly connected to the driving mechanism, and at least a portion of the second sub-tubular member is exposed from the first sub-tubular member; and
the locking ferrule component further comprises:
an intermediate member, an end of the intermediate member being located between the locking sleeve member and the first sub-tubular member and nested on the first sub-tubular member, a middle portion of the intermediate member being located between the second sub-tubular member and the locking sleeve member, and the other end of the intermediate member being provided with the abutting portion and located between the second tubular member and the locking sleeve member; and
an adapter member nested on the middle portion of the intermediate member and threadedly connected to the locking sleeve member;
wherein the driving mechanism is configured to drive the second sub-tubular member to slide relative to the first sub-tubular member, to allow the abutting portion to move along with the intermediate member to abut against or move away from the clamping mouth portion.

15. The photography support apparatus of claim 14, wherein the locking ferrule component further comprises:
an abutting member threadedly connected to the intermediate member and located between the ferrule component and the intermediate member, the abutting member being provided with the abutting portion, and the abutting portion engaging with the clamping mouth portion via a wedge fit.

16. The photography support apparatus of claim 14, wherein the leg further comprises:
a transmission mechanism, comprising:
a first mounting member mounted to the first sub-tubular member;
a first bolt comprising an end rotatably mounted to the first mounting member;
a second mounting member mounted to the second sub-tubular member, the second mounting member being threadedly connected to the other end of the first bolt; and
a transmission rod comprising an end drivingly connected to the driving mechanism and another end connected to the first bolt, the transmission rod being configured to be driven by the driving mechanism to move the first bolt, to allow the second mounting member to drive the second sub-tubular member to slide relative to the first sub-tubular member, so as to allow the intermediate member to drive the abutting portion to abut against or move away from the clamping mouth portion.

17. The photography support apparatus of claim 16, wherein the second tubular member comprises:
a third sub-tubular member and a fourth sub-tubular member slidably disposed within the third sub-tubular member, wherein the third tubular member is slidably disposed within the fourth sub-tubular member; and
the transmission mechanism further comprises:
a third mounting member mounted to the third sub-tubular member;
a second bolt having an end rotatably mounted to the third mounting member; and
a fourth mounting member mounted to the fourth sub-tubular member, the fourth mounting member being threadedly connected to the other end of the second bolt;
wherein the transmission rod passes through the first bolt and the second bolt, and the transmission rod is configured to drive the first bolt and the second bolt to move, to allow the first locking mechanism and the second locking mechanism to be actuated simultaneously, so as to configure the first tubular member and the second tubular member in either the relatively fixed state or the relatively slidable state, and configure the second tubular member and the third tubular member in either the relatively fixed state or the relatively slidable state.

18. The photography support apparatus of claim 17, wherein the leg further comprises:
a mounting mechanism connected to the mounting device, the mounting mechanism being disposed at an end of the first tubular member away from the second tubular member; and
the driving mechanism comprises:
a rotating member connected to the transmission rod; and
a handle member connected to the rotating member, the handle member being configured to be driven by an external force to allow the rotating member to drive the transmission rod to rotate.
